(19) United States
(12) Patent Application Publication
(10) Pub. No.: US 2024/0221515 A1
(43) Pub. Date: Jul. 4, 2024

(54) APPARATUS AND METHOD FOR DELIVERING E-LEARNING WITHOUT THE INTERNET AND/OR COMPUTERS

(71) Applicant: iZen ai, Inc., Union City, CA (US)

(72) Inventors: Gajanan Bhat, Union City, CA (US); Laxmish Bhat, Union City, CA (US)

(73) Assignee: iZen ai, Inc., Union City, CA (US)

(21) Appl. No.: 18/089,907

(22) Filed: Dec. 28, 2022

(51) Int. Cl. G09B 5/02; H04L 9/32

(52) U.S. Cl. CPC G09B 5/02; H04L 9/3268

(57) ABSTRACT

An apparatus and a method for delivering e-learning to one or more computing devices and/or a TV/monitor without requiring internet connectivity. The apparatus includes an enclosing box, a wireless antenna or similar means of communicating to external devices without mechanical connection, display ports such as a High-Definition Multimedia Interface (HDMI) port, a power input port or other power source input mechanism, an ethernet port or other similar network connection, and a plurality of Universal Serial Bus (USB) ports or other similar communications ports. The enclosing box encloses a single-board computer that receives a storage device connected through the slot, and which includes one or more Operating Systems or a complete operating environment, a Learning Management System (LMS) software, one or more software tools to help one or more students learn-by-doing, and one or more e-learning courses.

### TECHNICAL FIELD

The present invention relates to electronic learning (herein e-learning), in particular to an apparatus and method for delivering e-learning without the Internet and/or full-function computers.

### BACKGROUND

e-learning has transformed the way we learn. But currently, there are over 3 billion people in the world without access to the Internet, including 19 million people in the US. This is resulting in a lack of equitable education and training opportunities for more than half of the world's population. Two-thirds of the world's school-age children—or 1.3 billion children aged 3 to 17 years old—do not have an Internet connection in their homes, according to a new joint report from UNICEF and the International Telecommunication Union (ITU). This is a digital canyon, not just a divide, that is preventing them from competing in the modern economy, costing their futures.

Even in the US, the digital divide is perpetuating inequalities that already divide our communities. Children and young people from the poorest households, in rural and underserved areas, are falling even further behind their peers and are left with very little opportunity to ever catch up. Even 18 months after the COVID-19 pandemic started, a Census Bureau study showed that 1 in 5 California households with K-12 students did not have sufficient Internet access for effective e-learning.

The situation has been particularly troubling for students of color: Black and Latino students are 30% to 40% more likely to have limited access to the internet, according to a recent UCLA report. The digital divide is complicated to solve.

There are some existing solutions in the art that try to solve similar problems such as non-patent literature titled “A Prototype of Wireless Portable Learning Management System to Support E-Learning in Remote Area” published by Albertus Satrio Bayuaji et. al. discloses a portable learning management system based on Raspberry Pi and MoodleBox. This system can be used locally as a server without internet connectivity, thus still providing basic LMS functionality. Teachers can upload their material in this portable system, and students can access it from their smartphone or laptop locally.

Further, US patent U.S. Pat. No. 8,731,454B2 issued to Doug Dohring talks about an e-learning lesson delivery platform comprising a digital processing device and a program that creates a lesson delivery server, wherein said server comprises: a plurality of learning activities, wherein said activities are organized according to an instructional plan designed to accomplish one or more educational objectives in at least one subject, wherein said plan identifies one or more activities for use in a guided environment and one or more activities for assignment as independent work; a module for displaying and providing access to said one or more activities in a guided environment; a module for assigning said one or more activities as independent work to one or more learners, wherein said module is only accessible by a mentor; and a module for displaying and providing access to activities assigned as independent work, wherein said module is accessible by a mentor or a learner.

There are also many historical devices that provide highly focused learning capabilities, ranging from large-scale flight simulators to small-scale training devices, typically capable of being used to train specific skills and tasks and involving special-purpose hardware mechanisms for emulating the operating environment. Some of these are associated with videos from World War 2 for things like parachute training, bomb sight usage, and similar sorts of activities. Similarly, there are many historical games and toys such as those used in carnivals, arcades, and other entertainments that allow a child to drive a car around a circle or exert other control over some aspects of the mechanism. These comprise a wide range of systems and methods that are not in the realm of modern e-learning, but that display some of the positive characteristics of automated learning systems using analog computing devices and feedback control systems or, in some cases, limited digital switching technologies. They existed before the Internet and in many cases before modern computers.

However, most of the existing e-learning solutions are not effective and require internet infrastructure. The cost of broadband is out of reach for many families. High-speed internet lines are scarce in rural areas. The fact that a student needs a computing device in addition to the Internet for e-learning, makes the situation only worse. e-learning should not be a privilege. Currently, learners are missing out on quality e-learning opportunities, as they do not have access to the Internet, computers, or the right content. They generally go to a nearby library/other facilities for access, which is restrictive and not available to use when/where needed. Further, these learners use books and other non-e-learning resources which are not very engaging or effective.

This specification recognizes that there is a need for an affordable, reliable, and scalable solution for e-learning, that can address the above-mentioned concerns, without requiring the Internet and/or full-function computers. Further, there is a need for an apparatus that can provide a long-lasting, broad, and deep impact by delivering e-learning content to anyone, anywhere, anytime, without the need for the Internet and/or full-function computers.

### SUMMARY

According to example embodiments illustrated herein, there is provided an apparatus for delivering e-learning content to one or more computing devices and/or a screen, without requiring a connection to the Internet. The apparatus includes an enclosing box, a slot, a wireless antenna or similar means of communicating to external devices without mechanical connection, one or more display ports such as a High-Definition Multimedia Interface (HDMI) port, a power input port, or other power source input mechanism, an optional ethernet port or other similar network connection, and a plurality of Universal Serial Bus (USB) ports or other similar communications ports. The box encloses a single-board computer that receives a memory card or similar storage device connection through a slot, and which incorporates one or more Operating Systems or complete operating environments, Learning Management System (LMS) software, one or more software tools to help one or more students learn-by-doing, and one or more e-learning courses. The e-learning content is organized according to a curriculum plan designed to accomplish one or more educational objectives or specific workplace-aligned skill development. The wireless antenna or similar mechanism is configured for wirelessly communicating between the apparatus and one or more computing devices. The HDMI port or a similar display port is configured for presenting the digital content from the apparatus on a display screen through an HDMI cable or other similar connection means. The power input port or another similar mechanism for transmitting power to the apparatus powers the apparatus using the connected computing device, a wall electrical outlet, a battery pack, a solar power bank a transmitted power source, or other similar means. The optional ethernet or similar port connects the apparatus to the Internet and/or a local network when possible and needed. The USB or similar ports receive signals from a plurality of input devices such as a mouse and/or a keyboard.

In one embodiment, the computing devices comprise a desktop computer, a laptop, a smartphone, a tablet, or a smart TV without the Internet access.

In another embodiment, the display screen comprises a LED monitor/TV, an organic light-emitting diode (OLED or organic LED) monitor/TV, a TFT (thin-film transistor) monitor/TV, a plasma screen monitor/TV, a billboard screen, or an LCD screen built on to box itself, and optionally includes touch input mechanisms performing functions similar to that of other input devices.

In another embodiment, the storage device is a field-replaceable SD-RAM or similar storage device connection through the slot.

In another embodiment, the e-learning content and the application program can be updated over the Internet or a local network when needed and possible.

In another embodiment, the application program facilitates one or more teachers for monitoring the learning progress of one or more learners, and the overall e-learning process, including the learner experience.

In another embodiment, the apparatus stores a “public key” to verify the e-learning content on the storage device before loading the operating environment and other content, and a signed certificate on the single-board-computer used by the operating environment to verify that the apparatus is authorized to use the content on the storage device, all operating before loading and presenting a login option to the learners. This will prevent illegal copying and distribution of the software and the content. This will also ensure the integrity of the content, by stopping unauthorized people from altering the content intentionally or accidentally.

In another embodiment, the learners can seamlessly learn both online and offline, with the same user experience and effectiveness.

In another embodiment, a student's assessment data and the certificate of achievement can be reported and authenticated based on the learner's performance in quizzes and tests, just like an Internet-based learning platform.

According to example embodiments illustrated herein, there is provided a method of delivering e-learning content to one or more computing devices and/or a screen, without requiring a connection to the Internet. The method includes a step of inserting a storage device into a slot of an apparatus. The storage device stores an Operating System, a Learning Management System Software, and e-learning content. The e-learning content is organized according to a curriculum plan designed to accomplish one or more educational objectives or specific workplace-aligned skill development. The method presents the e-learning content on a display screen connected to an enclosing box through an HDMI cable. The enclosing box includes an HDMI port to receive the HDMI cable. The method includes a step of powering the enclosing box using the connected computing device, a wall electrical outlet, a battery pack, or a solar power bank through a power input port. The method includes a step of connecting to the Internet or a local network when possible and needed through an ethernet port. The method includes an option of receiving a plurality of input devices like a mouse and a keyboard through a plurality of Universal Serial Bus (USB) ports.

Accordingly, one advantage of the present invention is that the apparatus delivers e-learning to learners who have a computing device but no Internet connectivity.

Accordingly, another advantage of the present invention is that it can also deliver e-learning to people who do not have either a computer or the Internet connectivity, by letting them connect the apparatus directly to a TV/monitor.

Accordingly, another advantage of the present invention is that it provides a compact, portable, and easy-to-use apparatus that delivers a similar user experience to other e-learning platforms, without the need for the Internet and/or computers, and/or infrastructure power.

Accordingly, another advantage of the present invention is that it provides an option to seamlessly move between online and offline modes.

Accordingly, another advantage of the present invention is that it provides an option to learn fully offline.

Accordingly, another advantage of the present invention is that it provides the flexibility of custom or white-labeled platforms/programs as needed.

Other features of embodiments of the present invention will be apparent from the accompanying drawings and from the detailed description that follows.

Yet other objects and advantages of the present invention will become readily apparent to those skilled in the art following the detailed description, wherein the preferred embodiments of the invention are shown and described, simply by way of illustration of the best mode contemplated herein for carrying out the invention. As we realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

In the figures, similar components and/or features may have the same reference label in the figures' components of the same type may be distinguished by following the reference label with a second label that distinguishes among the similar components. If only the first reference label is used in the specification, the description applies to any one of the similar components having the same first reference label irrespective of the second reference label.

FIG. 1 illustrates a schematic diagram representing various components of an apparatus for delivering e-learning content to one or more computing devices or a TV/monitor, without the Internet, in accordance with a preferred embodiment of the present disclosure;

FIG. 2 illustrates a schematic diagram of a single board computer, in accordance with a preferred embodiment of the present disclosure;

FIG. 3 illustrates a block diagram of various layers of the present invention, in turn, a preferred embodiment of the present disclosure;

FIG. 4 illustrates a block diagram of the storage device and the apparatus, in accordance with a preferred embodiment of the present disclosure;

FIG. 5 illustrates a block diagram of the apparatus in server-mode, in accordance with a preferred embodiment of the present disclosure; and

FIG. 6 illustrates a block diagram of the apparatus in console mode, in accordance with a preferred embodiment of the present disclosure.

### DETAILED DESCRIPTION

The present invention is best understood concerning the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

The present application discloses a widely applicable apparatus and a method, providing different options to those with constraints, and delivering education and training programs for anyone, anywhere, making e-learning more equitable. If learners have a computer/device but no Internet, one or more learners (currently up to 20 at a time) can connect wirelessly to the apparatus, treating the box just like a Wi-Fi access-point, but without any Internet, router, etc. Users can access the apparatus using a desktop, a laptop, an iPad, or a smartphone. As will be apparent to anyone skilled in the art, these examples of such devices are only exemplary of other devices that may be used for such access.

All they need to do is to connect the apparatus to their laptop, wall outlet, or a battery pack for power. If learners do not have either a computer or the Internet connectivity, they can connect the apparatus to a TV, a monitor, or any other display, using an HDMI or other suitable cable. They can use a wired or wireless mouse (and a keyboard if needed for a course) or use the touch or other input features of the video display, their cellular phone, voice-to-text, or another input device as may be available. The learning content of the present realization of the invention is portable and the administrator of the present apparatus can leverage both new and existing e-learning programs from iZen and/or other providers.

The present apparatus addresses the digital divide that impedes skill-development opportunities for rural small organizations and people from disadvantaged and underserved communities. However, the platform provided by the present apparatus is widely applicable and there are many commercial and socially impactful applications.

The present invention will be positioned as iZen-LEAP™ (Learning Engagement and Access Platform). The learning “engagement” and “access” are the two facets of this offering: The “Learning Engagement” comes from the fact that (1) The apparatus will deliver e-learning programs developed by experts from industry and academia, aligned with the workplace demands and job roles. (2) The content is developed with an instructional design for end-to-end learner experience and usability.

The following are some of the use cases where the present apparatus could be deployed:

1) Schools and colleges can use the present apparatus to address the digital divide in providing e-learning for all students.

2) Rural businesses can use the present apparatus for affordable access to e-learning for workforce development to meet current demands and future readiness.

3) Any organization can improve Diversity, Equity, and Inclusion (DEI): a) By providing upskilling opportunities to people who would otherwise be left out. This is especially helpful to women, minorities, and underserved communities; and b) By educating employees, managers, and leaders on the importance and the means to achieve DEI (using the DEI course developed by iZen or others).

4) People on the go can use iZen-LEAP™ to learn or refer to instructions for complex operations or machinery. e.g., a) Teaching people how to use complex equipment in the field (e.g., Electric grid and solar maintenance); and b) Military personnel deployed in the field who need to use new/complex equipment.

5) Organizations handling any emergency can use iZen-LEAP™ to provide instructions and training references without any Internet connectivity and/or computers and/or infrastructure-power and be prepared for disasters.

6) Restricted environments like prisons can use iZen-LEAP™ for mindset and skill development programs.

Hence, the present apparatus can have a measurable impact to transform our communities.

Accordingly, one advantage of the present invention is that the apparatus can be operated in offline-mode so that local provisioning of service is possible. Support for updates and exchange of grading and other information is operable when connected to the Internet.

The learners just need to connect their computing devices to the apparatus wirelessly and start learning, without the Internet. The apparatus can be used with a TV or other screens without the Internet and computers. The apparatus can be updated quickly as new learning materials, and teaching methods become available. Further, the apparatus can help in developing custom programs and provide a complete solution that can deliver with or without computers and/or the Internet.

It must also be noted that, as used in this specification and the appended claims, the singular forms “a,” “an” and “the” include plural referents unless the context dictates otherwise.

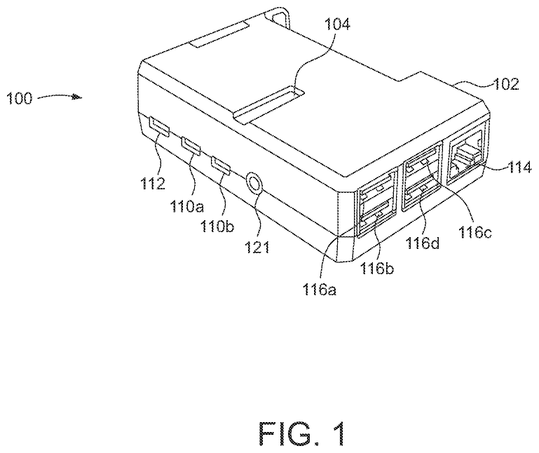

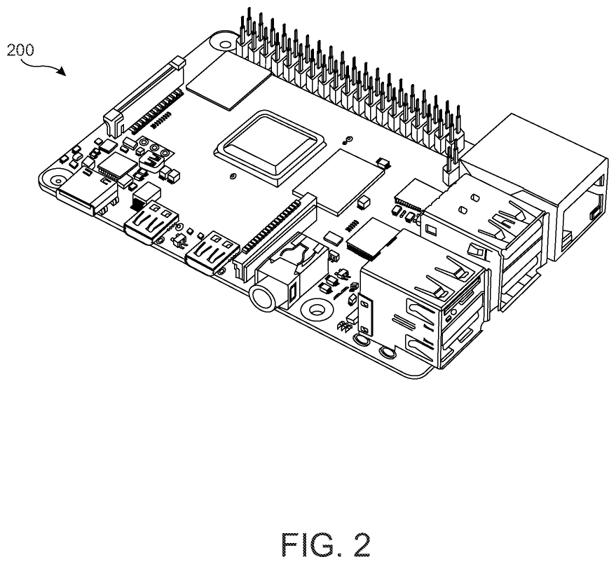

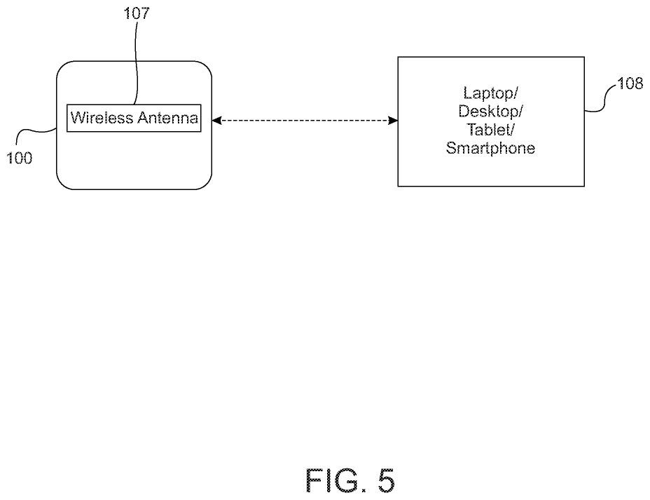

FIG. 1 illustrates a schematic diagram representing various components of an apparatus (100) for delivering e-learning content to one or more computing devices (108) (shown in FIG. 5) and/or TV/monitor (122), without the Internet connectivity, in accordance with a preferred embodiment of the present disclosure. An apparatus (100) is provided for delivering e-learning content to one or more computing devices (108) without the Internet and/or computer. The apparatus (100) includes an enclosing box (102), a slot (104), a wireless antenna (107) or similar means of communicating to external devices without mechanical connection, a High-Definition Multimedia Interface (HDMI), or a similar display port (110a, and 110b), a power input port (112), an ethernet port (114), and a plurality of Universal Serial Bus (USB) ports (116a, 116b, 116c, and 116d). The enclosing box (102) includes a single board computer (200) that hosts an Operating System, an LMS, software tools to help one or more students learn-by-doing, and an array of e-learning courses. In an embodiment, the enclosing box (102) has a dimension of 4×2×1 inches, that contains adequate computing, communication, and storage capacity. In an embodiment, the apparatus (100) includes an audio port (121) to connect speakers or other audio output devices to the computing devices (108). FIG. 2 illustrates a schematic diagram of the single board computer (200), in accordance with a preferred embodiment of the present disclosure. FIG. 2 is explained in conjunction with FIG. 1. In an embodiment, the single-board computer (200) is a circuit board that includes microprocessors, memory, input/output (I/O), and other components required for a functional computer.

The slot (104) receives a storage device (106) that stores e-learning content and an application program to access the e-learning content. The e-learning content is organized according to a curriculum plan designed to accomplish one or more educational objectives or specific workplace-aligned skill development. The HDMI port (110a, and 110b) is configured for presenting the digital content from the apparatus (100) on a display screen through an HDMI cable (120). The power input port (112) powers the apparatus (100) using the connected computing device (108), a wall electrical outlet, a battery pack, or a solar power bank. The ethernet port (114) connects the apparatus (100) to the Internet or a local network when possible and needed.

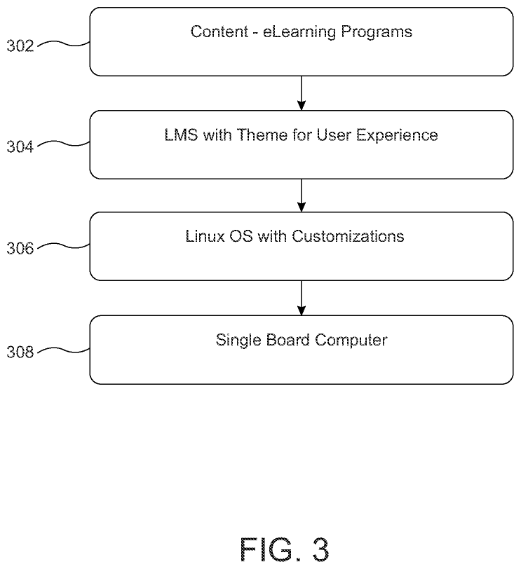

FIG. 3 illustrates a block diagram of various layers of the present invention, in turn, a preferred embodiment of the present disclosure. FIG. 3 is explained in conjunction with FIG. 1. The various layers of the present invention include e-learning content and the application program (software application) (302); a Learning Management System (LMS) with a theme for user experience (304); a Linux OS with customization (306), and a single board computer (308). In an embodiment, the e-learning content and the application program can be updated over the Internet or a local network. In an embodiment, the application program facilitates one or more teachers for monitoring the learning progress of one or more learners.

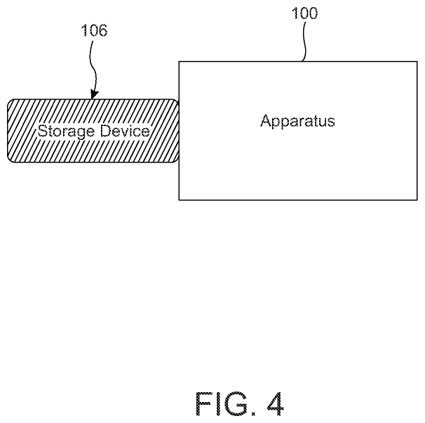

FIG. 4 illustrates a block diagram of the storage device (106) and the apparatus (100), in accordance with a preferred embodiment of the present disclosure. FIG. 4 is explained in conjunction with FIG. 1. In an embodiment, the storage device (106) is a field-replaceable SD-RAM memory-card or similar storage device connection through the slot to store the software and e-learning content. This is essential to make sure that the apparatus (100) can update software and augment e-learning programs for those who already have the apparatus (100). This helps in keeping e-learning content, mechanisms, and hardware modular, and easily serviceable. There are two things to address with this approach: (1) Someone may illegally copy the storage device and distribute it. (2) Someone may alter the content or mechanisms, intentionally or accidentally, impacting the authenticity or reliability of the content and learning outcomes. To address these concerns, the apparatus (100) will be enhanced with a new feature for data integrity and IP protection.

In another embodiment, the apparatus (100) boots up using a hardware “bootloader” which is in the apparatus (100) itself. This loads the operating environment, LMS application, and e-learning content from the storage device. In an embodiment, the apparatus (100) is enabled with a step for verification during this process, to make sure that only authorized storage devices will run, and only run on an authorized apparatus. To achieve this, the storage device or memory-card includes a “public key” which will verify the content on the memory-card before loading the operating environment and other content, and a signed certificate on the apparatus hardware used by the operating environment to verify that the apparatus is authorized to use the content on the memory-card, all operating before loading and presenting a login option to the learner. If someone copies the memory-card and tries it on an unauthorized apparatus (similar to the present apparatus), the verification would fail and the application will not load. If someone tries to use altered or unauthorized content on the apparatus, the apparatus hardware will prevent its use. This step will use the Software Bill of Materials (SBOM), which has emerged as a key building block in software security and risk management. To ensure content confidentiality, we will add options for encrypting the content and user data. This can “lock” the memory-card providing added IP protection. The main challenge here is to ensure acceptable levels of performance, after adding the encryption-decryption process. This step will also likely apply the SBOM methodology.

To assure against man-in-the-middle attacks and similar sorts of mechanisms, additional verification of physical operating parameters will be explored for high-consequence environments.

In an embodiment, the learners seamlessly learn both online and offline, with the same user experience and effectiveness. The software and learning content are stored on a field-replaceable memory-card. For any learners who do not have the Internet connectivity even for the upgrade process, we can simply mail a new memory-card with updated software or new content. If the learners have occasional internet access, they can connect the apparatus to the Internet at their local library, school, or workplace and update the apparatus. For content updates, the learners need to enter an authentication code, which they would receive when they purchase the new course. The apparatus will also implement end-to-end authentication of content using its public key and verify other operating parameters for higher surety applications. This will likely apply the SBOM methodology.

If the learner does not have a student account in the Internet-based LMS (like https://academy.izen.ai/ or others), an account will be created there, corresponding to the account on the apparatus, with access to the same set of courses.

Learner-data (activity completion status, quiz scores, posts, etc.) will be synchronized between the two systems. If the learner is logged in to the apparatus, there will be no additional authentication needed.

For the e-learning content, Internet-based LMS is always considered to be the latest and will be downloaded to the apparatus, if there are any updates required, upon authentication.

Learners can use their Chromebook or an Android tablet for e-learning simply by connecting to the apparatus wirelessly (without the Internet). However, it would be better if learners could do so without the hardware apparatus, but by using a virtual apparatus on these platforms as a software application. For both platforms, the present solution will be used as a Linux application. The LMS and content will run within the Linux application. This will add more options for the learners with constraints. This will be secured with the same mechanisms used for current software distributions on these platforms and augmented by SBOM mechanisms.

In an embodiment, a student's assessment data and the certificate of achievement can be reported and authenticated, just like an Internet-based learning platform. In certain user scenarios like compliance training at a workplace, or a school, there is a need to provide certificates of completion or achievement. In a typical online learning scenario, the LMS enables the administrator to track and authenticate such certificates. However, in a completely offline learning scenario, this can be challenging. In a first use case: a) When a learner has the opportunity to go online occasionally, the apparatus can be synchronized with the Internet-based LMS regarding the certificate (and course progress, test scores, etc.). The Internet-based LMS can provide a verifiable certificate to the administration (from school or workplace). In the second use case: b) When a learner completes a course completely offline, we need to manage this differently.

When a learner meets all the defined requirements (like activity completion, minimum scores in tests and quizzes, etc.), the apparatus generates a certificate locally using its ‘public key’ as a signing key and with a QR code as the output. The learner can take a snapshot of the QR code from their phone and send it to their administrator electronically (email/text), or they can print the certificate with the QR code and mail it to the admin through regular post. The QR code provides a more authentic way to communicate the certificate from the apparatus to the admin, who can then update their records on the Internet-based LMS as needed. The QR code can be verified by the corresponding private key held by iZen or another issuer and used to provide a public-key verifiable counter-signature.

FIG. 5 illustrates a block diagram of the apparatus (100) in server mode, in accordance with a preferred embodiment of the present disclosure. FIG. 5 is explained in conjunction with FIG. 1. The wireless antenna (107), or similar means of communicating to external devices without mechanical connection, is configured for wirelessly connecting the apparatus (100) to one or more computing devices (108). Examples of computing devices (108) include but are not limited to a desktop computer, a laptop, a smartphone, a tablet, or a smart TV without Internet access. In operation, one or more learners (currently up to 20) can connect to one apparatus (100), wirelessly, treating the apparatus (100) like a Wi-Fi access point, but without any Internet, router, etc. The learners can access the apparatus (100) using a desktop, laptop, iPad, or smartphone. The learners need to power up the apparatus (100) by connecting it to a laptop, wall outlet, or a battery pack for power.

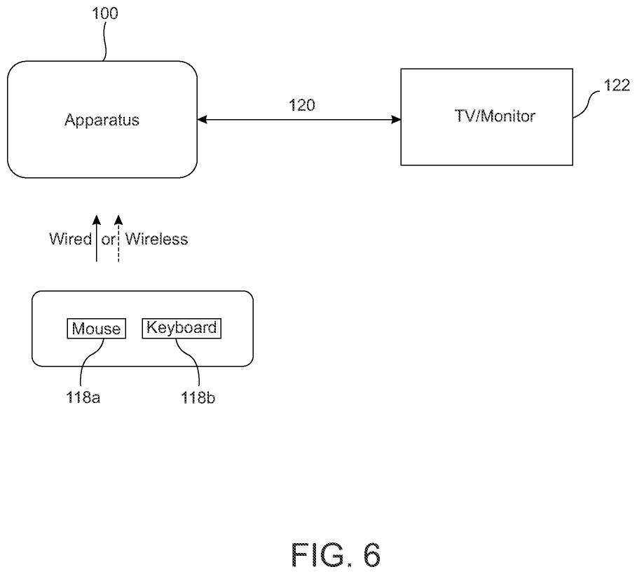

FIG. 6 illustrates a block diagram of the apparatus (100) in console mode, in accordance with a preferred embodiment of the present disclosure. FIG. 6 is explained in conjunction with FIG. 1. The USB ports (116a, 116b, 116c, and 116d) receive a plurality of input devices like a mouse (118a) and a keyboard (118b). In an embodiment, the display screen comprises a LED monitor/TV (122), an organic light-emitting diode (OLED or organic LED) monitor/TV, a TFT (Thin Film Transistor) monitor/TV, a plasma screen monitor/TV, a billboard screen, or an LCD screen built on to box itself. In operation, learners connect the apparatus (100) to a TV, a monitor, or any display, using an HDMI cable. The learners can use a wired or wireless mouse. If the course requires considerable keyboard input, they can use a wired/wireless keyboard. Otherwise, the virtual-keypad provided would suffice for the login and basic key inputs.

Thus, using the apparatus (100), learners can access e-learning programs from anywhere, anytime, with or without the Internet and/or a full-function computer.

Having described the specific preferred embodiments of the invention concerning the accompanying drawings, it will be appreciated that the present invention is not limited to that precise embodiment and that various changes and modifications can be affected therein by one of ordinary skill in the art without departing from the scope of the invention defined by the appended claims.

While, for purposes of simplicity of explanation, the apparatus and methodology are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter.

Throughout the specifications of the present disclosure, the term “comprising” means including but not necessarily to the exclusion of other elements or steps. In other words, the term comprising indicates an open list. Furthermore, all directional references (such as but not limited to, upper, lower, inner, outer, upward, downward, inwards, outwards, right, left, rightward, leftward, inside, outside, top, bottom, above, below, vertical, horizontal, clockwise, and counter-clockwise, lineal, axial and/or radial, or any other directional and/or similar references) are only used for identification purposes to aid the reader's understanding of illustrative embodiments of the present disclosure, and may not create any limitations, particularly as to the position, orientation, or use unless specifically set forth in the claims.

Similarly, joinder references (such as but not limited to, attached, coupled, connected, accommodated, and the like and their derivatives) are to be construed broadly and may include intermediate members between a connection of segments and relative movement between segments. As such, joinder references may not necessarily infer that two segments are directly connected and in fixed relation to each other.

As will be readily apparent to those skilled in the art, the present invention may easily be produced in other specific forms without departing from its essential characteristics. The present embodiments are, therefore, to be considered as merely illustrative and not restrictive, the scope of the invention being indicated by the claims rather than the foregoing description, and all changes which come within therefore intended to be embraced therein. Many variations, modifications, additions, and improvements are possible. More generally, embodiments in accordance with the present disclosure have been described in the context of preferred embodiments. Functionalities may be separated or combined in procedures differently in various embodiments of the disclosure or described with different terminology. These and other variations, modifications, additions, and improvements may fall within the scope of the disclosure as defined in the appended claims.

While embodiments of the present invention have been illustrated and described, it will be clear that the invention is not limited to these embodiments only. Numerous modifications, changes, variations, substitutions, and equivalents will be apparent to those skilled in the art, without departing from the scope of the invention, as described in the claims.

1. An apparatus for delivering e-learning content to one or more computing devices and/or a TV/monitor without internet connectivity, comprising:
an enclosing box enclosing a single board computer, comprising:
a slot for inserting a storage device, wherein said storage device stores one or more of an Operating System, a Learning Management System Software, and e-learning content, wherein said e-learning content is organized according to a curriculum plan designed to accomplish one or more educational objectives or specific workplace-aligned skill development;
a wireless antenna using which one or more external computing devices wirelessly connect to the apparatus and access e-learning content;
at least two HDMI ports configured to connect with a display screen to the apparatus through an HDMI cable, wherein the display screen is configured to present the e-learning content received from the apparatus;
a power input port configured to provide power to the apparatus using a wall electrical outlet, a battery pack, or a solar power bank;
and
a plurality of USB ports configured to receive a plurality of input devices, wherein the enclosing box has a dimension of 4×2×1 inches.

2. The apparatus of claim 1, wherein the computing devices comprise a desktop computer, a laptop, a smartphone, a tablet, or a smart TV without internet access.

3. The apparatus of claim 1, wherein the display screen comprises a LED monitor/TV, an organic light-emitting diode (OLED or organic LED) monitor/TV, a TFT (Thin Film Transistor) monitor/TV, a plasma screen monitor/TV, a billboard screen, or an LCD screen affixed to the apparatus.

4. The apparatus of claim 1, wherein said storage device is a field-replaceable SD-RAM memory card connected through said slot.

5. The apparatus of claim 1, wherein the e-learning content and an application program are updated over a local network.

6. The apparatus of claim 5, wherein the application program facilitates one or more teachers for monitoring the learning progress of one or more learners.

7. The apparatus of claim 1, wherein the said apparatus stores a “public key” to verify the e-learning content on the storage device before loading an operating environment, and a signed certificate on the single board computer used by the operating environment to verify that the apparatus is authorized to use the e-learning content on the storage device.

8. The apparatus of claim 6, wherein said learners seamlessly learn online and/or offline.

9. The apparatus of claim 1, wherein one or more students' assessment data and a certificate of achievement are reported and authenticated.

10. A method of delivering e-learning content to one or more learners through computing devices and/or a TV/monitor without internet connectivity, comprising:
inserting a storage device into a slot of an apparatus, wherein said storage device stores an Operating System, a Learning Management System Software, and/or e-learning content, wherein the e-learning content is organized according to a curriculum plan designed to accomplish one or more educational objectives or specific workplace-aligned skill development;
presenting said e-learning content through a display screen connected to an enclosing box through at least two HDMI ports;
powering the apparatus through a connected computing device, a wall electrical outlet, a battery pack, or a solar power bank through a power input port;
connecting to the Internet or a local network when possible and needed through an ethernet port; and
receiving a plurality of input devices through a plurality of USB ports, wherein the enclosing box has a dimension of 4×2×1 inches.

11. The method of claim 10, wherein the at least two High-Definition Multimedia Interface (HDMI) ports to receive an HDMI cable.

12. The method of claim 10, wherein the input device comprising a mouse and a keyboard, wherein the USB ports comprising a plurality of Universal Serial Bus (USB) ports.

13. The method of claim 10, wherein the computing devices comprise a desktop computer, a laptop, a smartphone, a tablet, or a smart TV without internet access.

14. The method of claim 10, wherein the display screen comprises a LED monitor/TV, an organic light-emitting diode (OLED or organic LED) monitor/TV, a TFT (Thin Film Transistor) monitor/TV, a plasma screen monitor/TV, a billboard screen, or an LCD screen affixed to the apparatus.

15. The method of claim 10, wherein the storage device is a field-replaceable SD-RAM memory card or similar storage device connecting through the slot.

16. The method of claim 10, wherein the e-learning content and an application program are updated over a local network.

17. The method of claim 16, wherein the application program facilitates one or more teachers for monitoring the learning progress of one or more learners.

18. The method of claim 10, wherein the e-learning content on the storage device is verified by a “public key” before loading the operating environment and other content.

19. The method of claim 10, wherein the learners seamlessly learn online and/or offline.

20. The method of claim 10, wherein one or more students' assessment data and a certificate of achievement are reported and authenticated online and/or offline.
